(19) United States
(12) Patent Application Publication
(10) Pub. No.: US 2006/0281023 A1
(43) Pub. Date: Dec. 14, 2006

(54) Negative photoresist composition

(76) Inventors: Takako Hirosaki, Kawasaki-shi (JP); Hiroshi Shimbori, Kawasaki-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/556,297

(22) PCT Filed: May 13, 2004
(86) PCT No.: PCT/JP04/06812

§ 371 Date: Nov. 10, 2005

(30) Foreign Application Priority Data
May 16, 2003 (JP) 2003-138873
Jun. 6, 2003 (JP) 2003-162060

(51) Int. Cl. G03C 1/00

(52) U.S. Cl. 430/270.1

(57) ABSTRACT

There is provided a negative photoresist composition, which is used in a method of forming a pattern in which an underlayer film is provided on a substrate, a photoresist film formed from the negative photoresist composition is provided on top of the underlayer film, the photoresist film is selectively exposed, and the underlayer film and the photoresist film are then simultaneously subjected to a developing treatment, and which enables favorable resolution to be achieved. This composition includes (A) an alkali-soluble resin, (B) an acid generator that generates acid on irradiation, and (C) a cross-linking agent, and the acid generator (B) includes an onium salt containing a cation with no hydrophilic groups.

### TECHNICAL FIELD

The present invention relates to a negative photoresist composition, and more specifically to a negative photoresist composition that can be used favorably in the formation of electronic elements such as magnetic heads and GMR elements and the like.

Priority is claimed on Japanese Patent Application No. 2003-138873, filed May 16, 2003, and Japanese Patent Application No. 2003-162060, filed Jun. 6, 2003 the contents of which are incorporated herein by reference.

### BACKGROUND ART

In the production of fine structures within magnetic heads and the like, ion etching using a magnetic film as a target (etching film) is commonly used, and ion milling is a widely used form of ion etching. FIG. 1A through FIG. 1E show schematic illustrations (side sectional views) of each of the steps in the formation of an electrode using typical ion milling and sputtering.

First, as shown in FIG. 1A, a magnetic film 2′ is laminated on top of a substrate 1, and a base film (an underlayer film) 3′ that is soluble in alkali developing solution and a resist film 4′ are then laminated sequentially on top of the magnetic film 2′. Subsequently, selective irradiation is conducted through a mask pattern from above the resist film 4′, using a light source such as i-line radiation or a KrF excimer laser. Alkali developing is then conducted, thereby dissolving certain areas of the resist film 4′ (the exposed portions in the case of a positive resist, or the unexposed portions in the case of a negative resist), and generating a resist pattern 4 with a substantially rectangular cross section. At this point, the base film 3′ positioned below those portions of the resist film 4′ removed by the alkali developing is also removed by the developing solution, and because the base film 3′ has a higher level of alkali solubility than the resist film 4′, the alkali developing generates a lift-off pattern 5 such as that shown in FIG. 1B, which includes a base film 3′ pattern 3 of narrow width, and a resist pattern 4 of the resist film 4′ of greater width.

When ion milling is then conducted using this pattern 5 as a mask, then as shown in FIG. 1C, the magnetic film 2′ surrounding the pattern 5 is etched away, forming a magnetic film pattern 2 beneath the pattern 5 and in the immediate vicinity thereof.

When sputtering is then conducted, an electrode film 6 is formed on top of the pattern 5, and on top of the substrate 1 in the vicinity of the magnetic film pattern 2, as shown in FIG. 1D.

Finally, when an alkali developing solution is then used again to dissolve the pattern 3 of the base film 3′, the resist pattern 4 of the resist film 4′ is removed, and a magnetic head 10 such as that shown in FIG. 1E, including the substrate 1, the magnetic film pattern 2 of a predetermined width formed on top of the substrate 1, and the electrode film 6 formed surrounding the pattern 2, can be obtained by a so-called lift-off method. The patent reference 1 listed below proposes a method of forming a taper-shaped resist pattern using a non-chemically amplified novolak positive resist composition.

(Patent Reference 1)

Japanese Unexamined Patent Application, Fist Publicaton No. 2002-110536

However, in these methods of forming this type of lift-off pattern 5, only methods that use positive photoresist compositions have been proposed, and until now, no negative photoresist compositions optimized for lift-off methods have come into practical use. Furthermore, the selection of materials for such resist films is difficult, and the desired levels of resolution have been unattainable.

### DISCLOSURE OF INVENTION

An object of the present invention is to provide a negative photoresist composition that can be applied to a method of forming a lift-off pattern, and yields favorable resolution, and more specifically, to provide a negative photoresist composition that can be used favorably in the formation of electronic elements such as magnetic heads and GMR elements and the like.

In order to achieve this object, a first aspect of the present invention is a negative photoresist composition, which includes (A) an alkali-soluble resin, (B) an acid generator that generates acid on irradiation, and (C) a cross-linking agent, and is used in a method of forming a pattern in which an underlayer film is provided on a substrate, a photoresist film formed from the negative photoresist composition is provided on top of the underlayer film, the photoresist film is selectively exposed, and the underlayer film and the photoresist film are then simultaneously subjected to a developing treatment, wherein the acid generator (B) includes an onium salt containing a cation with no hydrophilic groups.

Furthermore, a second aspect of the present invention is a negative photoresist composition, which includes (A) an alkali-soluble resin, (B) an acid generator that generates acid on irradiation, and (C) a cross-linking agent, and is used in a method of forming a pattern in which an underlayer film is provided on a substrate, a photoresist film formed from the negative photoresist composition is provided on top of the underlayer film, the photoresist film is selectively exposed, and the underlayer film and the photoresist film are then simultaneously subjected to a developing treatment, wherein the dissolution rate generated by the developing solution used in the developing treatment is within a range from 3.0 to 40.0 nm/second.

Furthermore, a third aspect of the present invention is a negative photoresist composition, which includes (A) an alkali-soluble resin, (B) an acid generator that generates acid on irradiation, and (C) a cross-linking agent, and is used in the formation of a magnetic head element, wherein the acid generator (B) includes an onium salt containing a cation with no hydrophilic groups.

Furthermore, a fourth aspect of the present invention is a negative photoresist composition, which includes (A) an alkali-soluble resin, (B) an acid generator that generates acid on irradiation, and (C) a cross-linking agent, and is used in the formation of a magnetic head element, wherein the dissolution rate generated by the developing solution used in the developing treatment is within a range from 3.0 to 40.0 nm/second.

According to the present invention, a negative photoresist composition is provided which exhibits good resolution, is able to be applied to methods of forming lift-off patterns, and can also be used favorably in the formation of electronic elements such as magnetic heads and GMR elements and the like.

### BRIEF DESCRIPTION OF THE DRAWINGS

FIG. 1A through FIG. 1E are schematic illustrations showing the sequence of steps for a patterning process using a lift-off resist pattern.

### BEST MODE FOR CARRYING OUT THE INVENTION

As follows is a more detailed description of the present invention.

[Alkali-Soluble Resin (A)]

An alkali-soluble resin (A) used in the present invention must by soluble in an alkali developing solution, but become alkali-insoluble through an interaction with a cross-linking component, and any of the conventional resins that have been used as negative chemically amplified alkali-soluble resin components can be selected. For example, novolak resins, polyhydroxystyrenes, and copolymers of hydroxystyrene and styrene can be favorably used. In a copolymer of hydroxystyrene and styrene, the ratio between hydroxystyrene and styrene (hydroxystyrene:styrene) is preferably within a range from 90 to 70:10 to 30.

Polyhydroxystyrene in which from 3 to 40 mol % of the hydrogen atoms of the hydroxyl groups have been substituted with alkali-insoluble groups, thus suppressing the alkali solubility, are also suitable. Furthermore, hydroxystyrene-styrene copolymers in which from 5 to 30 mol % of the hydrogen atoms of the hydroxyl groups of the hydroxystyrene units have been substituted with alkali-insoluble groups, thus suppressing the alkali solubility, are also suitable.

These alkali-insoluble groups are substituents that lower the alkali solubility of the unsubstituted alkali-soluble resin, and examples of these groups include tertiary alkoxycarbonyl groups such as tert-butoxycarbonyl groups and tert-amyloxycarbonyl groups, and lower alkyl groups of 1 to 5 carbon atoms such as methyl groups, ethyl groups, n-propyl groups, isopropyl groups, n-butyl groups, and isobutyl groups. Of these, from the viewpoints of being resistant to the effects of the surroundings during resist patterning, and enabling formation of a favorable resist pattern, lower alkyl groups of 1 to 5 carbon atoms are preferred, and isopropyl groups are particularly desirable. Of these possible resins, copolymers of hydroxystyrene and styrene with a polydispersity of 1 to 2.5 have a suitable level of alkali solubility, and enable ready adjustment of the dissolution rate of the negative photoresist composition, and are consequently particularly desirable.

The weight average molecular weight (the polystyrene equivalent value, this also applies to subsequent molecular weight values) of the alkali-soluble resin (A) is preferably within a range from 1,000 to 10,000, and in the case of chemically amplified negative resists for use with KrF radiation or electron beams (EB), values from 2,000 to 4,000 are even more preferred.

[Acid Generator Component (B)]

As the acid generator component (B) of the present invention, an onium salt containing a cation with no hydrophilic groups is used.

There are no particular restrictions on the anion of this onium salt, and conventional anions are suitable, although fluorinated alkylsulfonate ions, which generate a stronger acid, are preferred. In other words, fluoroalkylsulfonate ions in which either a portion of, or all of, the hydrogen atoms of the alkyl group have been fluorinated are preferred. The strength of the sulfonic acid falls as the number of carbon atoms of the alkyl group increases, or as the fluorination rate of the alkyl group (the proportion of fluorine atoms within the alkyl group) decreases, and consequently fluorinated alkylsulfonates in which all of the hydrogen atoms of an alkyl group of 1 to 10 carbon atoms have been fluorinated are particularly preferred. Perfluoromethanesulfonate ions and perfluorobutanesulfonate ions are particularly desirable, as they exhibit excellent acid strength, and favorable diffusivity within the resist film.

The cation that forms a salt with the above anion can use a cation with no hydrophilic groups selected from amongst the cations typically used in this type of acid generator. In this description, the term “hydrophilic groups” refers specifically to hydroxyl groups (—OH), carboxyl groups (—COOH), and alkoxy groups (—OR) and the like. By using an onium salt with a cation that contains none of these types of hydrophilic groups, the dissolution rate in the developing solution of the photoresist film formed from the resulting negative photoresist composition can be slowed, meaning favorable resolution can be obtained for the pattern formed by simultaneous developing of the underlayer and the photoresist film.

Specific examples of onium salts that can be used favorably as the acid generator component (B) include the sulfonium salts represented by a general formula (I) below, and the iodonium salts represented by a general formula (II) shown below.

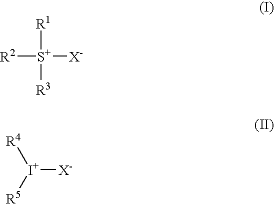

In these formulas, X⁻ represents an aforementioned anion, such as CₙF₂ₙ₊₁SO₃⁻ (wherein, n represents an integer from 1 to 10).

Furthermore, R¹ to R⁵ each represent, independently, a substituent group with no hydrophilic groups, and specific examples of preferred substituent groups include those represented by the chemical formulas (1) to (4) shown below. R¹ to R³ may be different groups, but are preferably the same. Similarly, R⁴ and R⁵ may be different groups, but are preferably the same.

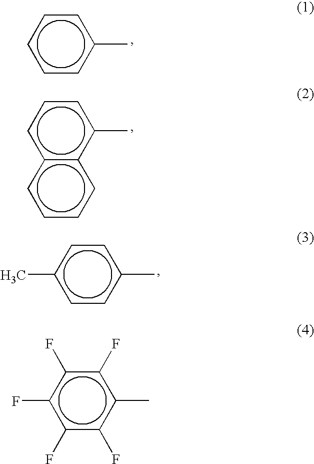

The onium salt of the component (B) may use either a single salt, or a combination of 2 or more different salts.

The quantity of the component (B) in a negative photoresist composition of the present invention is preferably within a range from 0.5 to 20 parts by weight, and even more preferably from 5 to 15 parts by weight, per 100 parts by weight of the component (A). If the quantity of the component (B) is less this range then pattern formation may be impossible, whereas if the quantity of the component (B) exceeds this range, there is a danger of a narrowing of the depth of focus, and a deterioration in the storage stability of the composition.

[Cross-Linking Agent Component (C)]

There are no particular restrictions on the cross-linking agent used as the component (C), which can be selected from any of the materials typically used as cross-linking agents in conventional chemically amplified negative photoresist compositions, including compounds containing at least one cross-link-forming group selected from amongst hydroxyalkyl groups and lower alkoxyalkyl groups.

Suitable examples of these cross-linking agents include compounds produced by reacting an amino group-containing compound such as melamine, acetoguanamine, benzoguanamine, urea, ethylene urea, or glycoluril with either formaldehyde or a combination of formaldehyde and a lower alcohol, thereby substituting the hydrogen atoms of the amino groups with hydroxymethyl groups or lower alkoxymethyl groups, and specific examples include hexamethoxymethylmelamine, bismethoxymethylurea, bismethoxymethylbismethoxyethylene urea, tetrakis-methoxymethylglycoluril, and tetrakis-butoxymethylglycoluril.

Of these, compounds such as bismethoxymethylurea, produced by reacting urea with either formaldehyde or a combination of formaldehyde and a lower alcohol, thereby substituting the hydrogen atoms of the amino groups with hydroxymethyl groups or lower alkoxymethyl groups, are particularly desirable as they enable the formation of favorable patterns regardless of variations in the blend quantity, thus simplifying the preparation of the negative photoresist composition.

The cross-linking agent component (C) may use either a single compound, or a combination of two or more different compounds.

The quantity of the component (C) in a negative photoresist composition of the present invention is preferably within a range from 3 to 50 parts by weight, and even more preferably from 10 to 20 parts by weight, per 100 parts by weight of the component (A). If the quantity of the component (C) is less than this range, then cross-linking formation does not progress adequately, meaning a favorable resist pattern cannot be obtained. If the quantity of the cross-linking agent (C) exceeds the above range, then there is a danger of a deterioration in the storage stability and the sensitivity over time, including problems such as the generation of particles within the resist composition during storage.

[Organic Solvent (D)]

A negative photoresist composition according to the present invention can be produced by dissolving the aforementioned component (A), component (B), component (C), and any of the other components described below, in an organic solvent (D).

The organic solvent (D) may be any solvent capable of dissolving each of the components to generate a uniform solution, and one or more solvents selected from known materials used as the solvents for conventional chemically amplified resists can be used.

Specific examples of the organic solvent (D) include ketones such as acetone, methyl ethyl ketone, cyclohexanone, methyl isoamyl ketone and 2-heptanone, polyhydric alcohols and derivatives thereof such as ethylene glycol, ethylene glycol monoacetate, diethylene glycol, diethylene glycol monoacetate, propylene glycol, propylene glycol monoacetate, dipropylene glycol, or the monomethyl ether, monoethyl ether, monopropyl ether, monobutyl ether or monophenyl ether of dipropylene glycol monoacetate, cyclic ethers such as dioxane, and esters such as methyl lactate, ethyl lactate, methyl acetate, ethyl acetate, butyl acetate, methyl pyruvate, ethyl pyruvate, methyl methoxypropionate, and ethyl ethoxypropionate. These organic solvents can be used alone, or as a mixed solvent containing two or more different solvents. In the present invention, particularly preferred solvents include those containing a hydrophilic solvent such as ethylene glycol, diethylene glycol, propylene glycol, the monomethyl ether, monoethyl ether, monopropyl ether, monobutyl ether or monophenyl ether of dipropylene glycol, methyl lactate, or ethyl lactate, either as the sole solvent, or as a mixed solvent with one or more of the other solvents listed above.

The quantity of the organic solvent (D) in a negative photoresist composition of the present invention is generally sufficient to produce a solid fraction concentration within the resist composition of 3 to 30% by weight, with the actual quantity selected in accordance with the desired resist film thickness. Here, the solid fraction refers to the combination of the components (A) through (C), together with any of the other components described below.

[Other Components]

In a negative photoresist composition of the present invention, in addition to the aforementioned component (A), component (B), and component (C), if desired, an amine (E) may be added as a quencher component in order to improve properties such as the resist pattern shape and the long term stability (the post exposure stability of the latent image formed by the pattern-wise exposure of the resist layer), and an organic carboxylic acid, or a phosphorus oxo acid or derivative thereof can also be added as another optional component (F), in order to prevent any deterioration in sensitivity caused by the addition of the component (E) and improve the substrate dependency characteristics. These components are widely used additives in chemically amplified negative photoresists.

As the component (E), an amine is preferred, and more specifically, a secondary aliphatic amine or tertiary aliphatic amine can be used.

Here, an aliphatic amine refers to an alkyl or alkyl alcohol amine of no more than 10 carbon atoms, and examples of these secondary and tertiary amines include trimethylamine, diethylamine, triethylamine, di-n-propylamine, tri-n-propylamine, triisopropylamine, tributylamine, tripentylamine, trioctylamine, diethanolamine, and triethanolamine, and of these, tertiary aliphatic amines with an alkyl group of 7 to 10 carbon atoms are preferred, and trioctylamine is the most desirable.

This component (E) is preferably used in a quantity within a range from 0.01 to 1.0 parts by weight per 100 parts by weight of the component (A).

Examples of suitable organic carboxylic acids for the component (F) include malonic acid, citric acid, malic acid, succinic acid, benzoic acid, and salicylic acid. Furthermore, examples of suitable phosphorus oxo acids or derivatives thereof include phosphoric acid or phosphorous acid or derivatives thereof such as esters, including phosphoric acid, phosphorous acid, di-n-butyl phosphate and diphenyl phosphate, phosphonic acid or derivatives thereof such as esters, including phosphonic acid, dimethyl phosphonate, di-n-butyl phosphonate, phenylphosphonic acid, diphenyl phosphonate, and dibenzyl phosphonate, and phosphinic acid or derivatives thereof such as esters, including phosphinic acid and phenylphosphinic acid, and of these, phenylphosphonic acid is particularly preferred.

The component (F) is typically used in a quantity within a range from 0.01 to 1.0 parts by weight per 100 parts by weight of the component (A).

Either of the component (E) and the component (F) may be used alone, or the two components may also be used together. By using the component (E) and/or the component (F), the top portion of the resist pattern forms more readily, enabling a reduction in edge roughness.

Miscible additives can also be added to a negative resist composition of the present invention according to need, including additive resins for improving the properties of the resist film, surfactants for improving the ease of application, plasticizers, stabilizers, colorants, and halation prevention agents.

By using an onium salt containing a cation with no hydrophilic groups, the solubility in the developing solution of the photoresist formed from the negative photoresist composition can be slowed. The solubility can be evaluated by determining the dissolution rate of the photoresist film formed from the negative photoresist composition in the developing solution used in the developing treatment. The dissolution rate for conventional negative photoresists is in the order of 500 nm/second, but photoresists with this type of fast dissolution rate exhibit unsatisfactory resolution.

In the present invention, by using the specified onium salt described above, the dissolution rate can be reduced, and this enables an improvement in resolution and a more favorable pattern shape. The dissolution rate of a negative photoresist composition of the present invention is preferably within a range from 3.0 to 40.0 nm/second, and even more preferably from 7.0 to 13.0 nm/second, and most preferably from 8.0 to 10.0 nm/second.

As the developing solution, aqueous solutions of TMAH (tetramethylammonium hydroxide), trimethylmonoethylammonium hydroxide, dimethyldiethylammonium hydroxide, or monomethyltriethylammonium hydroxide, with a concentration of 2.38% by weight, can be used favorably, although in the present invention, an aqueous solution of tetramethylammonium hydroxide is preferred.

The values for the dissolution rates of negative photoresist compositions in this description were determined using the method described below. First, the photoresist composition of the present invention is applied to a silicon wafer, and a prebake is conducted to form a photoresist film. Following measurement of the film thickness of the photoresist film, the wafer is immersed in a 2.38% by weight aqueous solution of TMAH (the developing solution). The time taken for the photoresist film to be dissolved completely is measured, and this time is used to determine the degree of thickness loss of the photoresist film per unit of time (nm/second).

In this description, the photoresist film thickness loss determined in this manner is used as the dissolution rate for the photoresist.

Next is a description of a method of forming a pattern using a negative photoresist composition of the present invention. A resist composition of the present invention can be used favorably in the formation of a pattern for ion etching, wherein the film to be etched is a magnetic film. Examples of ion etching include anisotropic etching such as ion milling.

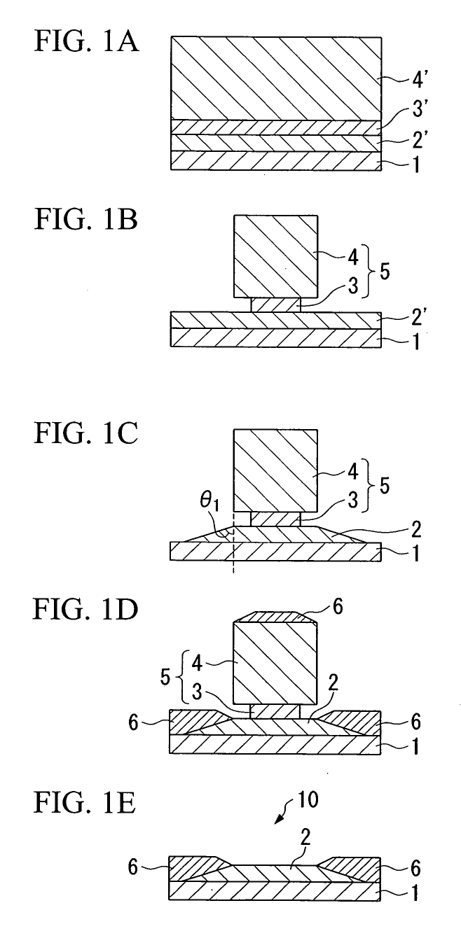

Pattern formation and ion etching using a negative photoresist composition of the present invention can be conducted either by a lift-off method, using the same sequence of steps shown in FIG. 1A through FIG. 1E, or by a non-lift-off method in which an underlayer is not provided. As follows is a description of a typical lift-off method.

There are no particular restrictions on the substrate 1, and a silicon wafer or the like can be used. The substrate 1 may have been subjected to a surface improvement treatment using a silane coupling agent such as hexamethyldisilazane (HMDS).

As the magnetic material used in a magnetic film 2′ on top of the substrate 1, conventional materials can be used, and examples include materials containing elements such as Ni, Co, Cr, or Pt.

A material such as polymethylglutarimide (hereafter abbreviated as PMGI), manufactured by Shipley Co., Ltd., can be used as the coating liquid used for forming a base film (underlayer) for the magnetic film 2′, and this coating liquid is applied using a spin coater, and is then dried to form the underlayer film 3′. The thickness of the underlayer film 3′ is typically from 10 to 100 nm, and preferably from 30 to 80 nm.

A resist film 4′ provided on top of the underlayer film 3′ is formed by applying a negative photoresist composition of the present invention using a spinner or the like, and then conducting a prebake (PAB treatment). The prebake conditions vary depending on factors such as the nature of each of the components within the composition, the respective blend proportions, and the thickness of the applied film, although typical conditions include a temperature of 70 to 150° C., and preferably from 80 to 140° C., for a period of 0.5 to 60 minutes. The thickness of the resist film 4′ is typically from 50 to 10,000 nm, and preferably from 100 to 2,000 nm.

A negative photoresist composition according to the present invention exhibits sensitivity at 248 nm, and can therefore be exposed using a KrF excimer laser, but also exhibits sensitivity to electron beams, and can therefore also be applied to electron beam lithography.

In other words, selective exposure of the resist film 4′ may be either conducted through a mask using a KrF excimer laser, or with an electron beam (EB), and a combination of the two may also be used. Particularly in the case of very fine patterns, a method involving direct patterning of the resist film with an electron beam is preferred. In the present invention, selective exposure includes both exposure through a mask, and direct patterning. Furthermore, in the case of a pattern shape that includes a mixture of both comparatively wide portions and portions with very narrow line widths, the wide portions can be produced by selective exposure using a KrF excimer laser, and the portions of very narrow line width then produced by direct patterning using an electron beam.

The heating conditions in a PEB (post exposure baking) step conducted after the exposure step vary depending on factors such as the nature of each of the components within the composition, the respective blend proportions, and the thickness of the applied film, although typical conditions include a temperature of 80 to 160° C., and preferably from 90 to 130° C., for a period of 0.5 to 10 minutes.

Following completion of the PEB step, by conducting alkali developing using the developing solution described above, predetermined areas (the unexposed portions) of the resist film 4′ are developed and removed, thereby forming a resist pattern 4, and at the same time, those portions of the base film (underlayer film) 3′ positioned beneath the unexposed portions of the resist film 4′, and beneath the edges of the exposed portions, are also removed by the alkali developing solution, thereby forming a lift-off pattern 5.

The developing time can be set so as to obtain the desired resist pattern shape, but if the time is too short, then base broadening may occur within the pattern, and undissolved residues may occur within the unexposed portions or other portions, whereas if the time is too long, thickness loss can result, and consequently the developing time is preferably set within a range from 25 to 180 seconds, and most preferably from 30 to 120 seconds.

A negative photoresist composition of the present invention uses an onium salt containing a cation with no hydrophilic groups as the acid generator (B), thereby suppressing the alkali solubility of the photoresist film. As a result, not only does the resolution improve, but during the step for developing the resist film (upper layer) formed from the negative photoresist composition, the dissolution rate of the underlayer provided beneath the resist film is also suppressed.

Accordingly, in a lift-off resist pattern in which the pattern width of the underlayer is formed so as to be narrower than that of the resist pattern of the resist film (the upper layer), there is a danger with conventional photoresist compositions that when the width of the resist pattern (the upper layer) is narrowed, the width of the pattern of the underlayer may become overly narrow, resulting in pattern collapse, but in the present invention, because the dissolution rate of the underlayer film is suppressed, the phenomenon wherein the underlayer film undergoes excessive dissolution during the developing of the upper layer, causing the pattern width to become overly narrow, can be prevented, meaning miniaturization of the resist pattern (the upper layer) can be achieved while the occurrence of pattern collapse is suppressed.

Furthermore, because the dissolution rate of the underlayer film is suppressed, the developing margin of the developing solution-soluble underlayer film can be improved. In other words, for pattern width values within the preferred range for the underlayer film, the developing time (developing margin) required for obtaining these pattern width values can be lengthened.

Furthermore, because an onium salt is used for the component (B), the sensitivity margin can be effectively improved, meaning the rectangularity of the resist pattern can also be improved.

Accordingly, by using this type of negative photoresist composition, a lift-off resist pattern with excellent resolution can be formed, and the in-plane uniformity of the pattern dimensions can also be improved.

Furthermore, in a negative photoresist composition of the present invention, the dissolution rate in the developing solution is suppressed to a value within a range from 3.0 to 40.0 nm/second, and consequently, during the step of developing the resist film (the upper layer) formed from this negative photoresist composition, the rate of dissolution of the underlayer provided beneath the resist film is suppressed. Accordingly, the phenomenon wherein the underlayer film undergoes excessive dissolution during the developing of the upper layer, causing the pattern width to become overly narrow, can be prevented, meaning miniaturization of the resist pattern (the upper layer) can be achieved while the occurrence of pattern collapse is suppressed.

Furthermore, because the dissolution rate of the underlayer film is suppressed, the developing margin of the developing solution-soluble underlayer film can be improved.

Accordingly, by using this type of negative photoresist composition, a lift-off resist pattern with excellent resolution can be formed, and the in-plane uniformity of the pattern dimensions can also be improved.

### EXAMPLES

As follows is a description of an example of the present invention, although the scope of the present invention is in no way restricted by this example.

### Example 1

<Preparation of a Negative Resist Composition>

The component (A), the component (B), the component (C), the component (E), the component (F), and the other component described below were dissolved uniformly in the component (D), yielding a negative photoresist composition.

As the component (A), 100 parts by weight of a copolymer with a polydispersity of 2.0, containing 80 mol % of structural units derived from hydroxystyrene and 20 mol % of structural units derived from styrene, was used. The weight average molecular weight of this component (A) was 3,600.

As the component (B), 3.0 parts by weight of triphenylsulfonium trifluoromethanesulfonate was used per 100 parts by weight of the component (A).

As the component (C), 10.0 parts by weight of bismethoxymethylurea (product name: N-8314, manufactured by Sanwa Chemical Co., Ltd.) was used per 100 parts by weight of the component (A).

As the component (D), 1800 parts by weight of propylene glycol monomethyl ether was used per 100 parts by weight of the component (A).

As the component (E), 0.48 parts by weight of trioctylamine was used.

As the component (F), 0.15 parts by weight of salicylic acid was used.

In addition to these components, 0.1 parts by weight of a fluorine-based surfactant (product name: XR104, manufactured by Dainippon Ink and Chemicals, Incorporated) was also used.

The dissolution rate of the thus obtained negative resist composition was 8.0 nm/second.

<Resist Pattern Formation and Evaluation>

Using a spin coater, PMGI (product name: SFG 2F, manufactured by Microchem Corp., an alkali-developable underlayer material, polymethylglutarimide) was applied to the surface of a silicon wafer that had already undergone a surface improvement treatment with HMDS, and was then dried by heating at 180° C. for 300 seconds, thereby forming an underlayer film of thickness 65 nm.

The negative resist composition prepared above was applied to the top of this underlayer film using a spinner, and was then prebaked at 110° C. for 90 seconds, thus forming a resist film with a film thickness of 200 nm.

Subsequently, patterning was conducted using an electron beam lithography apparatus (product name: HL-800D, manufactured by Hitachi, Ltd.) set to 50 kV.

PEB treatment was then conducted at 120° C. for 90 seconds, a developing treatment was conducted by dripping a developing solution of TMAH with a concentration of 2.38% by weight onto the substrate for 30 seconds, and a rinse treatment was then performed, thus forming an isolated pattern with a width of 100 nm.

The thus obtained resist pattern had a lift-off pattern type cross-section, but no pattern collapse had occurred. In addition, the sensitivity margin was broad, little thickness loss of the resist pattern had occurred, and the rectangularity of the pattern was good.

Furthermore, in the EB exposure, the isolated line resolution limit was 50 nm.

### Comparative Example 1

As the component (A), 100 parts by weight of a copolymer with a polydispersity of 2.0, containing 85 mol % of structural units derived from hydroxystyrene and 15 mol % of structural units derived from styrene, was used. The weight average molecular weight of this component (A) was 3,600.

As the component (B), an acid generator represented by a formula (III) shown below (NDS-105, manufactured by Midori Kagaku Co., Ltd.) was used as an example of an onium salt containing a hydrophilic group, in a quantity equivalent to 1.5 parts by weight per 100 parts by weight of the component (A).

The component (C), the component (D), the component (E), and the component (F) were the same as in the example 1. In addition to these components, 0.1 parts by weight of a fluorine-based surfactant (product name: XR104, manufactured by Dainippon Ink and Chemicals, Incorporated) was also used.

The dissolution rate of the thus obtained negative resist composition was 50 nm/second.

Using the thus obtained negative photoresist composition, a resist pattern was formed in the same manner as the example 1. The resulting isolated line was 250 nm. Furthermore, thickness loss of the resist pattern was significant, and the sensitivity margin was small.

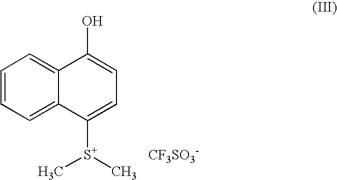

### Comparative Example 2

With the exception of replacing the component (B) with 1.0 parts by weight of α-(methylsulfonyloxyimino)-p-methoxyphenylacetonitrile, a negative resist composition was prepared in the same manner as the example 1. The dissolution rate of the thus obtained negative resist composition was 50 nm/second.

Using the thus obtained negative photoresist composition, a resist pattern was formed in the same manner as the example 1. The resulting isolated line was 250 nm. Furthermore, thickness loss of the resist pattern was significant, and the sensitivity margin was small.

### INDUSTRIAL APPLICABILITY

The present invention provides a negative photoresist composition which exhibits favorable resolution, is able to be applied to methods of forming lift-off patterns, and can also be used favorably in the formation of electronic elements such as magnetic heads and GMR elements and the like, and is consequently extremely useful industrially.

1. A negative photoresist composition, comprising (A) an alkali-soluble resin, (B) an acid generator that generates acid on irradiation, and (C) a cross-linking agent,
which is used in a method of forming a pattern in which an underlayer film is provided on a substrate, a photoresist film comprising said negative photoresist composition is provided on top of said underlayer film, said photoresist film is selectively exposed, and said underlayer film and said photoresist film are then simultaneously subjected to a developing treatment, wherein
said acid generator (B) comprises an onium salt containing a cation with no hydrophilic groups.

2. A negative photoresist composition, comprising (A) an alkali-soluble resin, (B) an acid generator that generates acid on irradiation, and (C) a cross-linking agent,
which is used in a method of forming a pattern in which an underlayer film is provided on a substrate, a photoresist film comprising said negative photoresist composition is provided on top of said underlayer film, said photoresist film is selectively exposed, and said underlayer film and said photoresist film are then simultaneously subjected to a developing treatment, wherein
a dissolution rate generated by a developing solution used in said developing treatment is within a range from 3.0 to 40.0 nm/second.

3. A negative photoresist composition according to claim 1, wherein a magnetic film is provided on said substrate, and said underlayer film is then provided on top of said magnetic film.

4. A negative photoresist composition, comprising (A) an alkali-soluble resin, (B) an acid generator that generates acid on irradiation, and (C) a cross-linking agent,
which is used in a formation of a magnetic head element, wherein
said acid generator (B) comprises an onium salt containing a cation with no hydrophilic groups.

5. A negative photoresist composition, comprising (A) an alkali-soluble resin, (B) an acid generator that generates acid on irradiation, and (C) a cross-linking agent,
which is used in a formation of a magnetic head element, wherein
a dissolution rate generated by a developing solution used in the developing treatment is within a range from 3.0 to 40.0 nm/second.

6. A negative photoresist composition according to claim 1, wherein said acid generator (B) is an onium salt with a fluorinated alkylsulfonate ion as an anion.

7. A negative photoresist composition according to claim 1, further comprising (E) a tertiary aliphatic amine containing an alkyl group of 7 to 10 carbon atoms.

8. A negative photoresist composition according to claim 1, wherein an electron beam is used for the selective exposure.
